(19) United States
(12) Patent Application Publication
(10) Pub. No.: US 2011/0291602 A1
(43) Pub. Date: Dec. 1, 2011

(54) Electromagnetic Pulse Engine

(75) Inventor: Kenneth Roach, Eustis, FL (US)

(73) Assignee: EMPE, LLC, Eustis, FL (US)

(21) Appl. No.: 12/788,372

(22) Filed: May 27, 2010

(51) Int. Cl. H02P 6/14; H02K 21/20

(52) U.S. Cl. 318/400.41; 310/156.12

(57) ABSTRACT

An electromagnetic pulse engine is disclosed. The engine includes a housing, a drum concentrically mounted within the housing and adapted to rotate therein, a plurality of permanent magnets mounted about an internal cylindrical wall of the drum, and a plurality of electromagnets mounted radially about an annular bearing. Successive permanent magnets of the plurality of permanent magnets have an opposing polarity facing inward, where at least one electromagnet of the plurality of electromagnets is adapted to be selectively energized and de-energized to attract a first permanent magnet and to repel a second permanent magnet to rotate the drum about the plurality of permanent magnets. In addition, the engine includes an axial shaft that is secured to the drum for rotating therewith, where the annular bearing supporting the plurality of electromagnets is secured against rotation relative to the axial shaft.

### BACKGROUND

I. Field of the Invention

The present invention relates generally to electric motors.

II. Background

A reduction in the reliance on fossil fuel powered engines has been at the forefront of reducing pollution to the environment. One alternative to the internal combustion engine is the electric motor. An electric motor uses electrical energy to produce mechanical energy instead of burning fossil fuels. For example, batteries have been used to power electric motors in vehicles. However, the batteries of electric powered vehicles typically have a limited range and the batteries are typically recharged by coal-fired power plants. In addition, a comparison of the cost per mile between an electric powered vehicle and a gasoline powered vehicle shows that gasoline powered vehicles are currently more economical. Further, the electric powered vehicle may not be that much more environmentally friendly than a gasoline powered vehicle because of its inefficiency.

Hybrid electric vehicles have been introduced to address the shortcomings in solely electric powered vehicles. Batteries are used to store energy and to power the electric motor of the vehicle and a combustion engine is used to extend the range of the batteries and electric motor. This is accomplished by combining the two power sources found in a hybrid car in different ways. For example, a parallel hybrid includes a fuel tank that supplies gasoline to the engine and a set of batteries that supplies power to the electric motor. Both the engine and the electric motor can turn the transmission at the same time and the transmission then turns the wheels of the vehicle. Another type of hybrid electric vehicle is a series hybrid where the gasoline engine turns a generator and the generator can either charge the batteries or power an electric motor that drives the transmission. The gasoline engine never directly powers the vehicle.

Although hybrid electric vehicles reduce the use of fossil fuels, the prior art hybrid vehicles maintain their reliance in part on gasoline. Accordingly, there is a need for an electric powered electromagnetic pulse engine that uses only electricity but is highly efficient to compete with internal combustion engines on a performance level while reducing the impact to the environment.

### SUMMARY

The following presents a simplified summary of one or more embodiments in order to provide a basic understanding of some aspects of such embodiments. This summary is not an extensive overview of the one or more embodiments, and is intended to neither identify key or critical elements of the embodiments nor delineate the scope of such embodiments. Its sole purpose is to present some concepts of the described embodiments in a simplified form as a prelude to the more detailed description that is presented later.

In a particular embodiment, an electromagnetic pulse engine is disclosed. The engine includes a housing, a drum that is concentrically mounted within the housing and adapted to rotate therein, a plurality of permanent magnets are mounted about an internal cylindrical wall of the drum, where successive permanent magnets of the plurality of permanent magnets having opposing polarity facing inward, and a plurality of electromagnets are mounted radially about an annular bearing, where at least one electromagnet of the plurality of electromagnets is adapted to be selectively energized and de-energized to attract a first permanent magnet and to repel a second permanent magnet to rotate the drum about the plurality of permanent magnets. An electronic control module may apply pulses of current to the electromagnets at a determined interval and duration to energize and de-energize the electromagnets to cause the drum to rotate at the desired revolution.

In addition, an axial shaft may be secured to the drum, which may be interfaced to a crankshaft, flywheel assembly, and transmission. The annular bearing that supports the plurality of electromagnets is secured against rotation relative to the axial shaft. The electromagnets may be energized using electrical DC current and controlled by logic gates, for example, diodes, switches, an electronic control module, or any combination thereof, to energize the plurality of electromagnets. A variable rheostat may be used to control the electric current flow to increase or decrease power input to the plurality of electromagnets. The plurality of permanent magnets may be rare earth magnets such as neodymium magnets.

In another particular embodiment, a face of each of the permanent magnets facing inward is angled relative to the internal cylindrical wall of the drum. The plurality of electromagnets may be energized and de-energized in pairs to balance the torque of the drum as the drum rotates.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 is a perspective view of a particular embodiment of an electromagnetic pulse engine;

FIG. 2 is an elevational view of the electromagnetic pulse engine shown in FIG. 1;

FIG. 3 is a front view of the electromagnetic pulse engine shown in FIGS. 1 and 2;

FIG. 4 is an elevational exploded view of an outer housing of the electromagnetic pulse engine shown in FIGS. 2-3;

FIG. 5 is front perspective exploded view of the outer housing of the electromagnetic pulse engine;

FIG. 6 is a perspective exploded view of an internal assembly of the electromagnetic pulse engine;

FIG. 7 is an elevational exploded view of the internal assembly of the electromagnetic pulse engine; and

FIG. 8 is a perspective exploded view of the internal assembly shown without the outer housing.

### DETAILED DESCRIPTION OF THE PREFERRED EMBODIMENT

The word “exemplary” is used herein to mean “serving as an example, instance, or illustration.” Any embodiment or design described herein as “exemplary” is not necessarily to be construed as preferred or advantageous over other embodiments or designs.

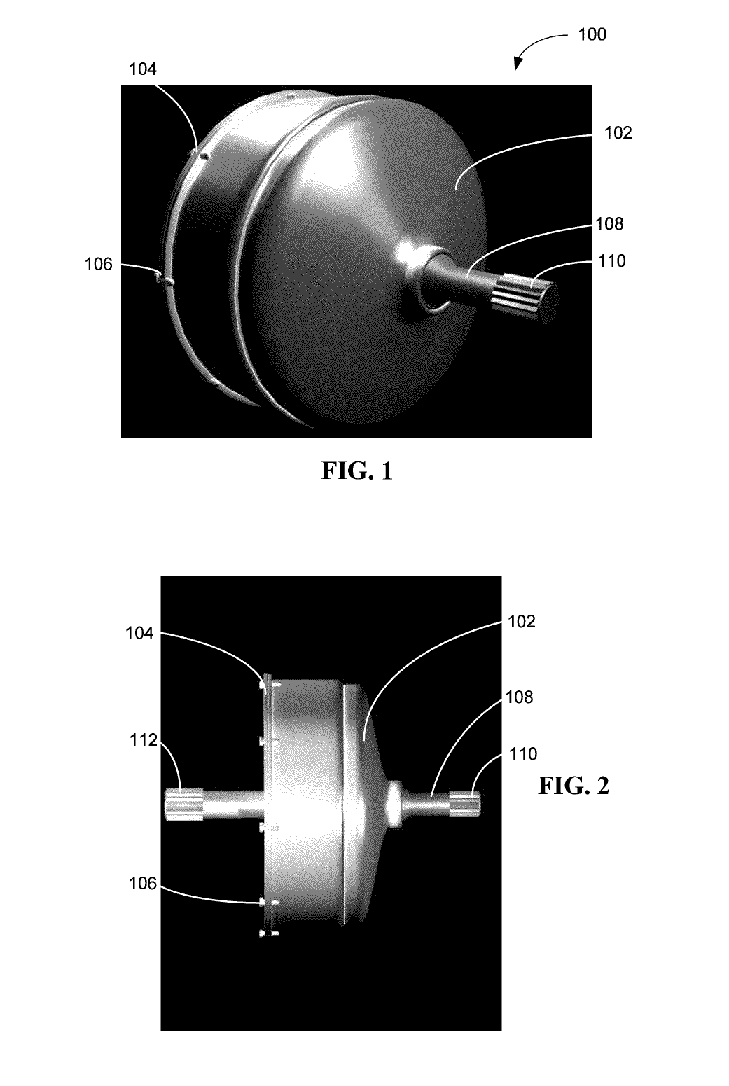

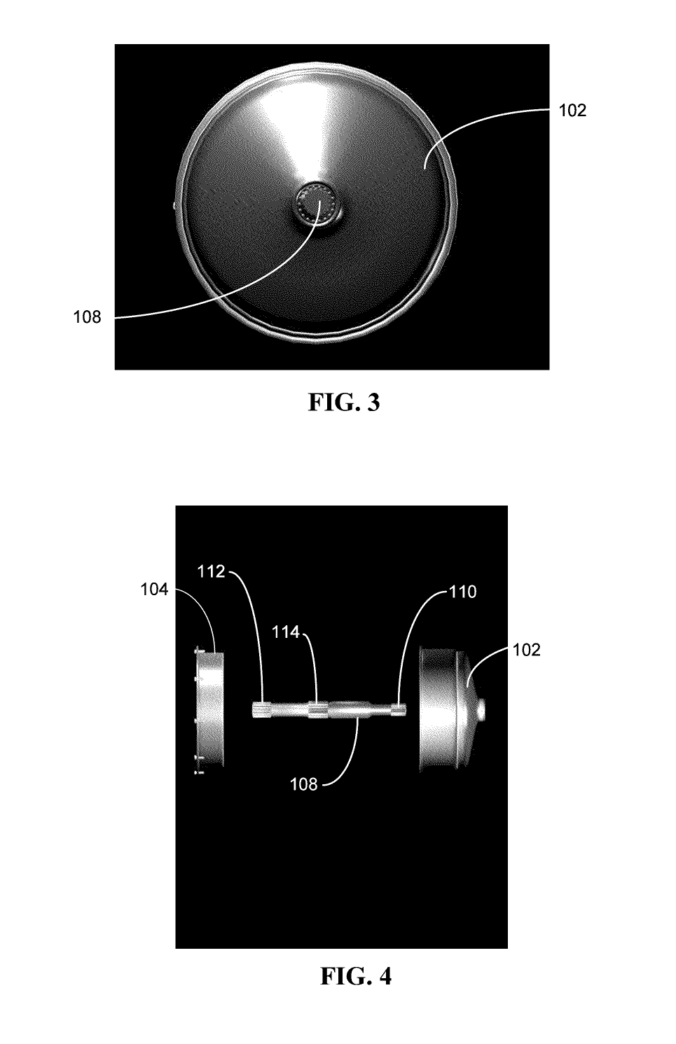

Referring to FIGS. 1, 2 and 3, a particular illustrative embodiment of an electromagnetic pulse engine is disclosed and generally designated 100. The engine 100 includes a cylindrical housing 102 that protects the components mounted therein. A front portion of the housing 102 is dome shaped, where sidewalls of the housing 102 extend rearward from the front portion. The housing 102 includes a removable rear cover 104, where sidewalls of the removable rear cover 104 are configured to slide within the rear portion of the housing 102. Bolts 106 or other fastening means are used to secure the rear cover 104 to the housing 102 and form an enclosed casing. An axial shaft 108 is concentrically located through apertures aligned through the front portion of the housing 102 and the rear cover 104. The front portion of the housing 102 includes a forwardly projecting bearing support having an antifriction annular bearing, where the bearing rotatably supports the axel shaft 108. The axial shaft 108 is journaled for rotation by the annular bearing. The annual bearing is attached/incorporated into the rear portion of the housing 102 itself and the rear cover 104. The length of the shaft 108 may necessitate incorporating an additional supportive bearing along the shaft's 108 length.

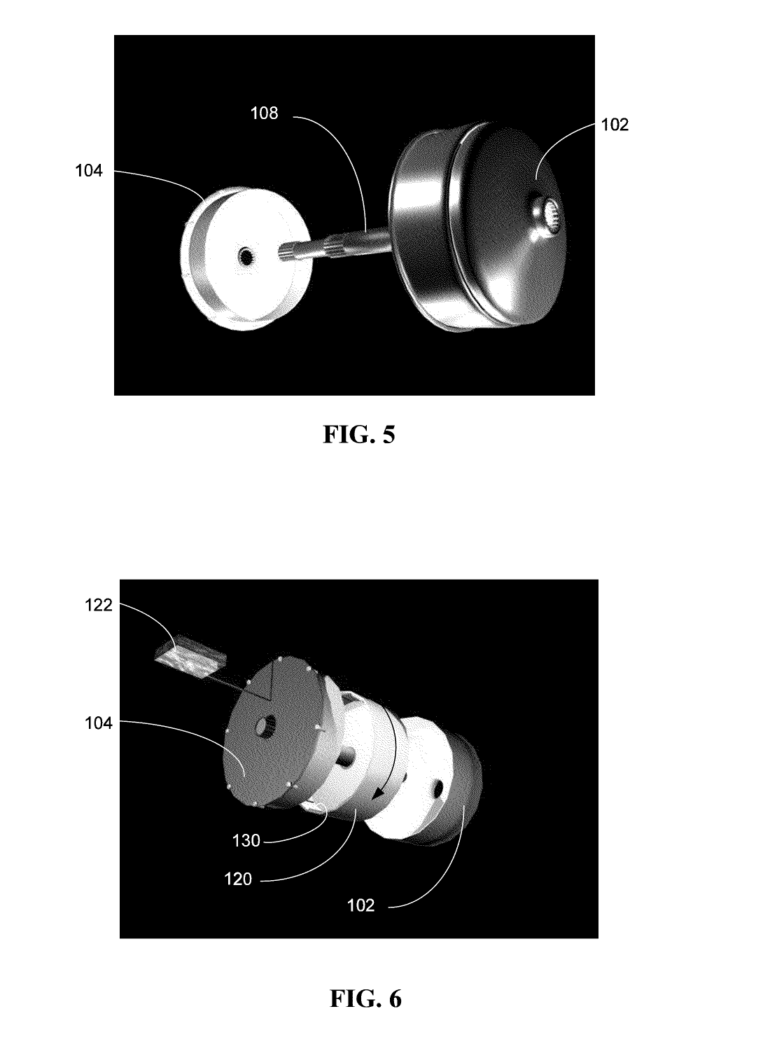

Referring now to FIGS. 4 and 5, the front portion of the housing 102 is removed from the rear cover 104. The axial shaft 108 may include a front spline connection 110 installed on the outer periphery of the shaft 108 and adapted to connect in meshed engagement to a flywheel or other gear in the same fashion known in the art for a crankshaft, torque converter/flywheel assembly and transmission for a vehicle.

The front spline connection 110 is disposed proximate to a first end of the shaft 108 and extends outside the housing 102. A rear spline connection 112 is disposed proximate a second end of the shaft 108 and extends outside the rear cover 104. An interior spline connection 114 is axially spaced within the housing 102 between the front spline connection 110 and the rear spline connection 112. The shaft 108 includes a shoulder 116 that is located on the shaft 108 where the shaft 108 exits the front portion of the housing 102.

Referring now to FIG. 6, a drum 120 is coupled to the axel shaft 108 by interior spline connection 114 for rotation therewith. A plurality of permanent magnets 130 are mounted about an internal cylindrical sidewall of the drum 102. Successive permanent magnets of the plurality of permanent magnets 130 have opposing polarity facing inward. Thus, there are an equal number of permanent magnets 130 having a positive polarity as there are permanent magnets 1033 having a negative polarity disposed about the drum 120. The plurality of permanent magnets may be rare earth magnets, for example, neodymium magnets. A face of each of the permanent magnets facing inward may be angled relative to the internal cylindrical wall of the drum 120.

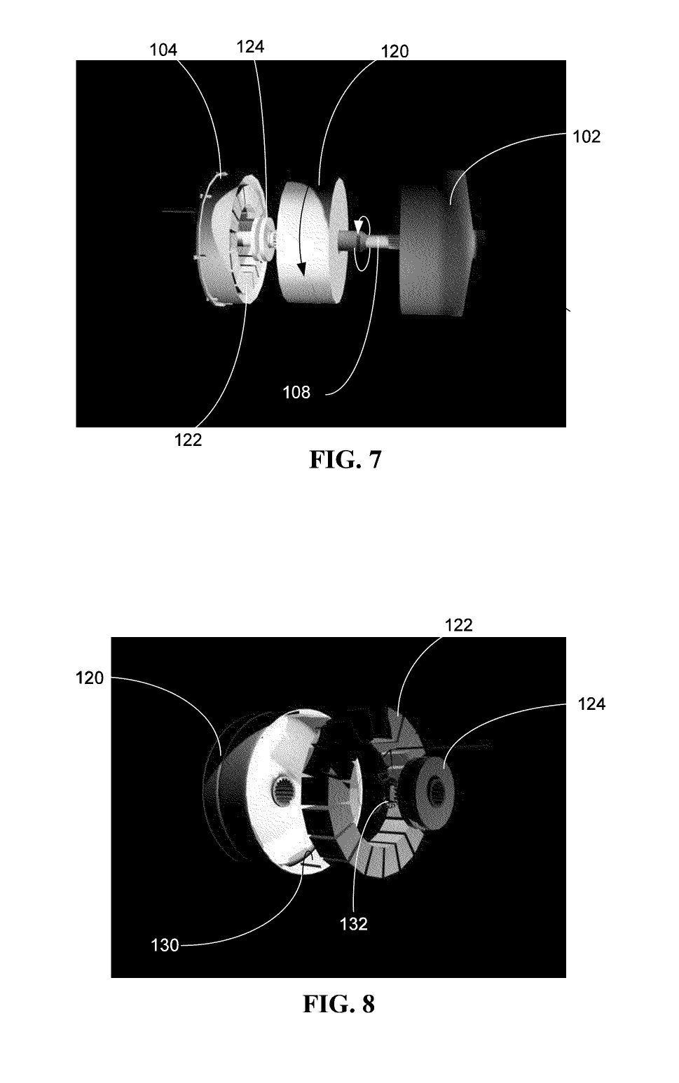

Referring now to FIGS. 7 and 8, a plurality of electromagnets 122 are mounted radially and biased against rotation. A pulley and wheel assembly 124 is illustrated as an example of an interface with existing pulley systems that the engine 100 can be adapted to. At least one electromagnet of the plurality of electromagnets 122 is adapted to be selectively energized and de-energized to attract a first permanent magnet and to repel an opposingly polarized second permanent magnet to cause the drum 120 to rotate. As the drum 120 is rotated in a first direction, the first permanent magnet is being attracted into the electromagnetic field of an energized first electromagnet. As the second permanent magnet reaches the electromagnetic field of the energized first electromagnet, the first electromagnet is de-energized to allow the opposingly polarized second magnet to continue to rotate in the first direction. The first electromagnet is energized when the magnetic field will cause the opposingly polarized second permanent magnet to be repelled from the electromagnetic field in the first direction. The physical location of each permanent magnet relative to the plurality of electromagnets 122 may be sensed in order to determine which electromagnet should be energized/de-energized and the timing of when each electromagnet should be energized/de-energized to rotate the drum 120.

The plurality of electromagnets 122 may be energized using electrical DC. Alternatively, AC current may be used. A circuit may be used to control the current to energize the electromagnets to pull an adjacent permanent magnet into the field of the electromagnet. Instead of reversing the energization applied to the electromagnet to push the permanent magnet out of the field of the electromagnet as in the prior art, the next sequential permanent magnet has an opposing polarity. Accordingly, the circuit is only required to turn the current on and off to the desired electromagnet. The circuit may include logic gates such as diodes, switches, an electronic control module, or any combination thereof, to energize the plurality of electromagnets.

The electronic control module 122 illustrated in FIG. 6 may be used to apply sequential pulses of current to the selected electromagnet. In addition, a variable rheostat may be used to control the electric current flow to increase or decrease power input to the plurality of electromagnets 122. The plurality of electromagnets 122 may be energized and de-energized in pairs to balance the torque of the drum 120 as the drum 120 rotates. The alternating forces of attraction and repulsion result in the drum 120 rotating, which in turn rotates the shaft 108 that can be used to power a vehicle, for example. The electronic control module 122, is controlled by mechanical linkage and is variable in electrical cyclic output or Hz and is also variable in channel output in accordance with the following parameters; 1 channel, 2 channels, 4 channels, 8 channels and a maximum of 16 channels. For example, each channel must produce sufficient amperage sent through a selected electromagnet 122 so that the electromagnet can overcome the applicable friction and other forces. The frequency is variable for each channel concurrently at a rate of 200 to 933.28 pulses per/sec. The electronic control module's 122 channel variability may be controlled based on need (as manually selected-shifter and/or based on rpm sensing feedback loop during various driving conditions via automatic transmission).

In one example, the electromagnetic pulse engine 100 includes eight electromagnets 122 and seven pairs of permanent magnets 130. In this example, N52 grade neodymium rare earth permanent magnets are designed to be angled at 45 degrees relative to the inner cylindrical sidewall of the drum 120 to create the greatest magnetic attraction and repulsion with each permanent magnet 130 creating a force of approximately 82 lbs. The electromagnets 122 are commercial off the shelf items producing a magnetic strength of approximately 82 lbs within a maximum current rating input. The combined angular momentum with all electromagnets 122 being energized and de-energized produces approximately 2,400 lbs of maximum torque using a vector analysis.

The need to keep the electromagnets 122 working together in pair helps to balance the torque of the drum 120 by opposing forces working concurrently. The greater number of electromagnets 122 “firing” creates greater torque in ft lbs for more power to drive a vehicle, for example. Accordingly, reducing the number of electromagnets “firing” at cruise speeds to maintain the drum's 120 angular momentum can be realized by “firing” less electromagnets 122 and thereby using the least current possible and conserving the energy supply and greater miles per charge.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.52(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An electromagnetic pulse engine, the engine comprising:
a housing;
a drum concentrically mounted within the housing and adapted to rotate therein;
a plurality of permanent magnets mounted about an internal cylindrical wall of the drum, wherein successive permanent magnets of the plurality of permanent magnets having opposing polarity facing inward; and
a plurality of electromagnets mounted radially about an annular bearing, wherein at least one electromagnet of the plurality of electromagnets is adapted to be selectively energized and de-energized to attract a first permanent magnet and to repel a second permanent magnet to rotate the drum about the plurality of permanent magnets.

2. The electromagnetic pulse engine of claim 1, further comprising an axial shaft secured to the drum.

3. The electromagnetic pulse engine of claim 2, wherein the annular bearing is secured against rotation relative to the axial shaft.

4. The electromagnetic pulse engine of claim 3, wherein the axial shaft is interfaced to a transmission.

5. The electromagnetic pulse engine of claim 4, wherein the at least one electromagnet is energized using electrical DC current.

6. The electromagnetic pulse engine of claim 5, wherein the plurality of electromagnets are controlled by logic gates.

7. The electromagnetic pulse engine of claim 6, wherein the logic gates include diodes, switches, an electronic control module, or any combination thereof, to energize the plurality of electromagnets.

8. The electromagnetic pulse engine of claim 7, further comprising a variable rheostat to control an electric current flow to increase or decrease power input to the plurality of electromagnets.

9. The electromagnetic pulse engine of claim 8, wherein the plurality of permanent magnets are neodymium magnets.

10. The electromagnetic pulse engine of claim 9, wherein a face of each permanent magnets facing inward is angled relative to the internal cylindrical wall of the drum.

11. The electromagnet pulse engine of claim 10, wherein the plurality of electromagnets are energized and de-energized in pairs to balance the torque of the drum as the drum rotates.

12. An electromagnetic pulse engine, the engine comprising:
a plurality of electromagnets mounted about the periphery of an axial shaft, wherein the plurality of electromagnets are secured against rotation; and
a plurality of permanent magnets mounted about an inner wall of a drum, wherein the drum is secured to the axial shaft and the drum is adapted to rotate about the plurality of electromagnets.

13. The electromagnetic pulse engine of claim 12, wherein successive permanent magnets of the plurality of permanent magnets having opposing polarity facing inward.

14. The electromagnetic pulse engine of claim 13, wherein at least one electromagnet of the plurality of electromagnets is adapted to be selectively energized and de-energized to attract a first permanent magnet and to repel a second permanent magnet to rotate the drum about the plurality of permanent magnets.

15. The electromagnetic pulse engine of claim 14, wherein the axial shaft is journaled for rotation by an annular bearing.

16. The electromagnetic pulse engine of claim 15, wherein the axial shaft is secured to a crankshaft, flywheel assembly, and transmission.

17. The electromagnetic pulse engine of claim 16, wherein the at least one electromagnet is energized using electrical DC current or AC current.

18. The electromagnetic pulse engine of claim 17, further comprising an electronic control module to apply sequential pulses of current to a selected electromagnet.

19. The electromagnetic pulse engine of claim 12, wherein a face of each permanent magnets facing inward is angled relative to the internal cylindrical wall of the drum.

20. The electromagnet pulse engine of claim 12, wherein the plurality of electromagnets are energized and de-energized in pairs as the drum rotates.
